(19) United States
(12) Patent Application Publication
(10) Pub. No.: US 2023/0016562 A1
(43) Pub. Date: Jan. 19, 2023

(54) CONTROLLING ON-TIME OF ENERGY MODULES OF AN ENERGY STORAGE

(71) Applicant: KK WIND SOLUTIONS A/S, Ikast (DK)

(72) Inventors: Anders Eggert MAARBJERG, Ulstrup (DK); Lóránd BEDE, Herning (DK)

(21) Appl. No.: 17/757,624

(22) PCT Filed: Dec. 17, 2020
(86) PCT No.: PCT/DK2020/050375

§ 371 Date: Jun. 17, 2022

(30) Foreign Application Priority Data
Dec. 23, 2019 (DK) PA 2019 70833

(51) Int. Cl. H02M 1/00; H02J 7/00; H02M 1/44; H02M 7/5387; H01M 10/42; H01M 10/48

(52) U.S. Cl. CPC H02M 1/0054; H02J 7/0013; H02J 7/0048; H02J 7/005; H02J 7/00712; H02J 7/0063; H02M 1/44; H02M 7/53871; H01M 10/425; H01M 10/486; H01M 10/482; H02J 2207/20; H02M 1/327

(57) ABSTRACT

The invention relates to a method of controlling the on-time of a plurality of energy modules of an energy storage. The energy storage comprising a plurality of series connected energy modules forming an energy module string. A string controller is controlling which of the individual energy modules that is part of a current path through the energy module string, by control of the status of a plurality of switches. The string controller is controlling the frequency of the energy module string voltage according to an electric system reference related to a system to which the energy storage is connected. And wherein the string controller is controlling the switches of the individual energy modules so that each of the individual energy modules that are required to be included in the current path to establish the energy modules string voltage are included in the current path for at least a minimum on-time.

### FIELD OF THE INVENTION

The invention relates to an energy storage comprising a plurality of independently controllable energy modules and a method of controlling the on-time of these energy modules.

### BACKGROUND OF THE INVENTION

DE102012209179 discloses an energy storage comprising a string comprising a plurality of battery modules. Each of the battery modules are connected to the string via a plurality of switches. The status of the switches is controlled by a controller to establish a desired output of the energy storage without specifying how the switches are controlled to establish this desired output.

U.S. Pat. No. 8,395,280 discloses a circuit arrangement comprising a multi-level converter, where at least two converter units is configured to have an electric charge storage unit. A switching arrangement is configured to provide an output voltage having a duty-cycle, the value of which changes at the beginning of e.g. every second discharge cycle to balance individual charge storage units. U.S. Pat. No. 8,395,280 teach how to establish a desired duty cycle of the individual storage units with the purpose of balancing the charge of the storage units.

A problem with the above prior art is that switching of the switches generates losses in terms of e.g. heat and electromagnetic disturbances.

### SUMMARY OF THE INVENTION

The above problem today is solved by choosing switches that can comply with high switching frequencies. Such switches are expensive generates more heat and are heavier compared to switches used in an energy storage controlled according to the present invention.

The present invention relates to a method of controlling the on-time of a plurality of energy modules of an energy storage. The energy storage comprising a plurality of series connected energy modules forming an energy module string, wherein each of the individual energy modules are connected to the energy module string by a plurality of switches configured in an H-bridge. Wherein a string controller is controlling which of the individual energy modules that is part of a current path through the energy module string, by control of the status of a plurality of switches. Wherein the string controller is controlling the frequency of the energy module string voltage according to an electric system reference of a system to which the energy storage is connected. And wherein the string controller is controlling the switches of the individual energy modules so that each of the individual energy modules that are required to be included in the current path to establish the energy modules string voltage are included in the current path for at least a minimum on-time.

This is advantageous in that it has the effect, that the switching frequency of the switches of the individual energy modules can be controlled to be above a lower switching time leading to a reduction of wear of the switches, reduction of switching losses and reduced higher harmonic noise.

Further this is advantageous in that it has the effect, that the SOC of the energy modules can be controlled so that if desired, one or more energy modules can be included in a heavier rotation that others. In this way the load and thereby wear of individual energy modules can be controlled.

Further this is advantageous in that it has the effect, that while the switching frequency on the energy module level is reduced, the bandwidth seen from the system level is maintained.

Further this is advantageous in that it has the effect, that the least one or two energy modules that is switched on (e.g. on top of a sinusoidal curve) is not the first that is switched off. Thereby, the on-time is controlled to a desired length leading to a controlled minimum on-time of the individual energy modules which is leading to a more balanced wear of the switches and reduced switching losses.

The electric system reference should be understood as a reference frequency, reference voltage, reference current or reference power received from a system to which the string of the energy storage/energy storage is connected. A reference frequency could either be a frequency of the voltage of the system i.e. the load to which the energy storage is connected such as a utility grid frequency (typically 50 Hz or 60 Hz), desired motor frequency, etc.

The electric system reference may be received from a controller or sensor of such system or from an energy storage controller. The latter may comprise predetermined system references that can be provided to the string controller and thereby used to control the frequency of the voltage of the string.

With the present invention, it is possible to achieve high control bandwidth with a reduced number of switching of the switches associated to the individual energy module. Further, it is ensured, that the individual energy modules are always turned on for a minimum on-time and at any moment the number of energy modules that is “turned on” is the number required by the string controller. Advantageously, reducing the number of switching of the switches associated to the individual energy modules, may reduce wear of the switches and reduce the temperature increase of the system caused by fast switching of the switches, thereby reducing or possibly eliminating the need for removing heat from the system for example by implementing heat sinks i.e. footprint of heat sinks can be reduced. Notice, that fast switching of the switches may be understood as high switching frequency of the switches. A further advantage of the minimum on-time of individual energy modules, is that it may reduce transients, which may reduce for example electromagnetic interference and high frequency disturbances in the energy storage system.

According to an exemplary embodiment, the string controller is establishing the on-time of the individual energy modules dynamically according to a dynamic performance evaluation of the plurality of energy modules of the energy module string.

On-time should be understood as the time an individual energy module is connected to the energy module string and thereby part of the current path through the energy module string and thereby the time it is being charged or discharged.

Energy storage should be understood as one or more strings of series connected energy modules. It should be noted, that batteries are the most common storage element of the energy modules, but e.g. capacitors could also be used.

Energy module should be understood as an energy storage module comprising a plurality of energy storage elements. Energy storage elements are preferably battery cells but could also be capacitors.

Energy module string (or simply string) should be understood as a plurality of series connected energy modules. Each individual of the energy modules are series connected via a plurality of switches preferably mounted on a switching module PCB.

One or more strings may be controlled to be either connected in series or in parallel by additional switches.

String controller should be understood as the controller monitoring one or more of state of charge (SOC; state of charge), state of health (SOH; State Of Health), voltage, temperature, etc. of the energy modules and based hereon perform a performance evaluation ranking the individual energy modules and controlling the switching module PCBs according to the ranking, input (such as power reference) from external controller/energy storage controller and/or overall control strategy, etc. to allow current to flow to or from the energy modules. The performance evaluation may be referred to as dynamic in that it is made while the energy storage is in use i.e. based on real-time measurements of electric system reference or electric energy storage module reference.

According to an embodiment of the invention, the overall control strategy i.e. which energy modules that are to be tuned on, off or bypassed and sequence hereof may be based on a sorting of the energy modules on a list according to the individual energy modules total or current on-time, state of charge, state of health, temperature, internal resistance, etc. Such list may below be referred to as dynamic performance list.

As an alternative to the performance list, a random module could be chosen by the string controller which has been turned on longer than the minimum on-time independent of location on the performance list.

System frequency for fundamental frequency should be understood as the frequency of the system (also referred to as load) to which the energy storage is connected. Hence, if the energy storage is connected to an electric AC system having a frequency of 50 Hz, the system frequency would be 50 Hz. It should be noted, that the system frequency may also be 0 Hz i.e. DC.

A desired system frequency (i.e. an example of an electric system reference) is in an embodiment provided to the string controller from an energy storage controller communicating with a controller external to the energy storage. In an alternative embodiment, the string controller is able to determine the system frequency of a system to which the energy storage is connected. In this embodiment, a power reference is typically communicated to the string controller from an external controller. In yet an alternative embodiment, the energy storage may supply a load or form a “local grid”. In this embodiment, if there is not external power (external power bus) available the external controller provides frequency information such as system frequency.

Controlling the energy module string voltage according to an electric system reference should in an embodiment be understood as controlling the frequency of the voltage of the energy module string to be similar to the frequency of the voltage of the electric system to which the energy storage is connected. Hence, the string controller is establishing an energy module string voltage having a frequency corresponding to the desired system frequency by controlling the on-time of the individual energy modules.

According to an exemplary embodiment, the string controller performs the dynamic performance evaluation prior to each turning on of an energy storage module. This is advantageous in that it has the effect, that the on-time of the individual energy modules are controlled according to real-time evaluation of input from the load, from measurements made at the individual energy modules or string or based on information of historic use of the individual energy modules.

According to an exemplary embodiment, the dynamic performance evaluation includes sorting the plurality of energy modules according to at least one of the list comprising: state of charge, state of health, temperature of the plurality of energy modules. Control of on-time of the individual energy modules is advantageous in that in this way it is ensured that one individual energy module is not always the last energy module to be connected and the first to be disconnected and thereby always the energy module that is on for the shortest time. This is advantageous in that it has the effect that higher harmonics of the module frequency are reduced, transients, etc is reduced.

According to an exemplary embodiment, the dynamic performance evaluation further includes that the selection of which energy module that is to be connected next to the current path complies with at least one of the conditions selected from the list comprising: minimum on-time, minimum temperature, able to be charge and able to be discharged.

According to an exemplary embodiment of the invention, the dynamic performance evaluation further includes sorting the plurality of energy modules into a dynamic performance list.

Sorting the energy modules into a dynamic performance list is advantageous, in that the dynamic performance list may constitute a reference to the state of each of a plurality modules, wherein the energy modules of the list may be sorted according to the dynamic performance evaluation.

This sorting of energy modules into a dynamic performance list may preferably be performed by the string controller. However in other embodiments of the invention, other controllers may carry out the sorting of energy modules into the dynamic performance list.

According to a further exemplary embodiment of the invention, sorting the plurality of energy modules into a dynamic performance list is based on at least one energy module parameter of the list comprising: on-time, state of charge, state of health, temperature and internal resistance.

Sorting the dynamic performance list based on for example state of charge, state of health, temperature of the plurality of energy modules and/or internal resistance, may be advantageous in that it constitutes reference to the dynamic performance of each of the plurality of energy modules. Advantageously, the list may be applied by the string controller, which based on the list determine which energy modules that should be turned on and/or turned off at which point in time.

The internal resistance of an energy module is dependent on multiple energy module parameters, including for example its size, state of charge, chemical properties, age, temperature, and the discharge current. Thus, it may be advantageous to monitor the internal resistance to obtain information regarding these energy module parameters and sort the energy modules according to one or more of these parameters.

In an embodiment of the invention, the sorting of energy modules into a dynamic performance list may be based on a linear or non-linear mathematical function of at least one of the following: on-time, state of charge, state of health, temperature of the plurality of energy modules, internal resistance. It may be an advantage that the sorting of energy modules into a dynamic performance list based on a weighting of at least one or more selected from the list of dynamic energy module parameters (or simply referred to as energy module parameters): on-time, state of charge, state of health, temperature of the plurality of energy modules, internal resistance.

In an embodiment of the invention, the sorting of energy modules into the dynamic performance list may be based on for example a weighted sum of one or more of the dynamic energy module parameters, such as for example a weighted average of one or more of the dynamic energy module parameters.

According to an embodiment of the invention, the sorting of energy modules into a dynamic performance list may be based on the temperature of the individual energy modules. However, in other implementations of the invention it may be advantageous to sort the energy modules based on for example SOC, SOH, internal resistance of the battery modules and/or on-time of energy modules. Sorting the dynamic performance list based on on-time may be beneficial, since the string controller may apply the list to select energy modules to turn on and/or turn off, such that the on-time among the plurality of energy modules are balanced.

Hence, dynamic performance evaluation should be interpreted as a real-time evaluation of energy module (operation) parameters of the energy modules and sorting of the energy module according to one or more of these operation parameters. The performance list can be updated with the control frequency, but the update frequency can be determine based on an acceptable range/distribution of e.g. SOC, temperature, SOH, etc.

Note that the on-time could be both the real-time on-time i.e. the time since an energy module has been turned on, but also the total on-time of an energy module since the energy module was installed in the energy storage. Further, note that the list of dynamic energy module parameters may also include cycle counts i.e. how many times an energy module has been discharged or completely discharged or completely discharged and subsequently fully charged.

Control of the on-time is advantageous in that it has the effect, that the SOC among the energy modules can be balanced as desired either to have an even distribution i.e. same level of SOC or control individual energy modules to have less or higher SOC than others. In the situation where not all energy modules are needed to establish a required amplitude of an energy module string voltage, the on-time of the superfluous energy modules is set to 0 (zero) i.e. not being used in the establishment of the energy module string voltage and therefore not connected to the current path.

Short on-time is in an embodiment understood with reference to the energy storage system regulation frequency and is a design choice. In a non-limiting exemplary embodiment, where the energy storage system regulation frequency (also sometimes referred to as control frequency) is 10 kHz, then to avoid losses in and load on individual parts of the energy storage such as switching losses and reduce EMC (EMC; Electro Magnetic combability) and EMI (EMI; Electro Magnetic Interference) disturbances, a short time of the switches associated with the individual modules i.e. the shortest/minimum on-time is one control period i.e. 100 us, alternatively two control periods i.e. 200 us in the above example. In another exemplary embodiment, the shortest on-time is above a lower limit between 80 us and 150 us.

It is understood that the shortest on-time may be the same as the minimum on-time. In a further embodiment according to the invention, the shortest on-time is 200 us, such as between 150 and 300 us. Increasing the shortest on-time and/or the minimum on-time may for example advantageously improve the reduction of the above described EMC and EMI disturbances and high frequency noise.

The module frequency (also sometimes referred to as switching frequency) should be understood as the frequency with which an individual energy module is connected to and from the current path through the energy module string i.e. the switching frequency of the semiconductor switches. Hence, seen from a load connected to the energy storage, the switching frequency of the string of energy modules is the switching frequency of one module times the number of modules in that the modules are phase shifted/interleaved. In other words, the effective switching frequency may be understood as the switching frequency of the individual modules multiplied by the number of modules.

Hence, by having a control frequency of e.g. 10 KHz potentially the semiconductor switches associated with one energy module can be turned on/off with a frequency of 10 KHz which is not desired. Therefore, to avoid such fast switching, a minimum on-time is determined and if not complied with, the string controller overrules the overall/normal control strategy and change sequence of switching (often timing in turning off energy modules). Accordingly, in the energy storage of the present invention it is possible to have a control frequency that is higher than the switching frequency. Advantageously, the switching losses may therefore be reduced while the control performance is maintained. Thus this is a further advantages over classical systems where the switching and control frequencies are closely tied together and the control frequency cannot be higher than the switching.

According to an exemplary embodiment, wherein the string controller is furthermore controlling the amplitude of the energy module string voltage according to input received from controllers external to the energy module string.

This is advantageous in that it has the effect, that in this way the direction of the current into the current path of the energy module string or out of the current path of the energy module string can be controlled. Accordingly, it can be controlled if the energy modules of the energy module string can be charged or can be discharged. This of course depends on if they are connected via their respective switching module PCBs to the current path or not, their state of charge, etc.

The input received from the external controller may be a frequency, current, voltage or power reference based on which the string controller is able to determine the number of energy modules needed to establish the desired output voltage. Further, the string controller establish the desired amplitude and frequency of the output voltage by selecting and switching of the individual energy modules of the energy module string according to the result of the performance evaluation and overall control strategy (i.e. if one module is to be in heavier rotation, minimum SOC of a module, etc.).

The external controllers providing control input to the string controller could be a current controller, voltage controller, grid controller, wind turbine controller, solar plant controller or controllers of systems to which the energy storage is connected such as a controller of a ship.

In an embodiment of the invention, the energy storage is a high powered energy storage for supplying for example stationary loads such as loads in a wind turbine. Therefore, typically the energy modules are located and mounted in one or more upright electric panels which can be manufactured at a factory, transported to site of the wind turbine and installed in the wind turbine.

According to an exemplary embodiment, wherein the module frequency is less than 2 kHz, preferably less than 1.5 kHz and most preferably less than 1 kHz. The low module frequency compared to the system regulation frequency (in an embodiment 10 kHz) is advantageous in that it has the effect, that the battery impedance is not exposed to high frequency and thereby better preserved.

According to an exemplary embodiment, wherein the control of the output from the energy storage is controlled by the string controller according to an overall control strategy selected from the list comprising: predetermined control scheme, state of charge of one or more energy modules or state of health of one or more energy modules.

The predetermined and/or overall control scheme is advantageous in that it has the effect, that in this way it is predetermined when to use which energy modules and thereby an equal distribution of wear of the battery modes is obtained. Further in this way, the on-time of the individual energy modules are also predetermined. Alternatively, the output from the energy storage is controlled according to measurements of state of charge, state of health, etc. or measurements based on which these can be derived.

According to an exemplary embodiment, wherein the performance evaluation includes a state of charge evaluation or a temperature evaluation established by the string controller based on input from a battery monitoring module monitoring the energy modules. This is advantageous if the energy storage is to be discharged in that it has the effect that the energy module having highest SOC could be controlled to have the longest on-time and/or the energy module having the lowest SOC could be controlled to have the shortest on-time. If the energy storage is to be charged, it is the other way around the energy module having the lowest SOC should have the longest on-time. A further advantage is that the energy module having lowest temperature could be controlled to have the longest on-time and/or the energy module having the highest temperature could be controlled to have the shortest on-time. If the energy storage is to be charged, it is the other way around the energy module having the highest temperature should have the longest on-time. In different implementations according to the invention, it may be advantageous to control the on-time differently based on for example temperature and/or state of charge.

According to an exemplary embodiment, wherein the performance evaluation includes a wear evaluation established by the string controller based on historic data of use of the energy modules. This is advantageous in that it has the effect, that the least worn out energy modules are used the most.

According to an exemplary embodiment, wherein the energy elements are battery cells. This is advantageous in that it has the effect, the resolution of the output voltage from the energy storage can be controlled by the number and / or capacity of the battery cells comprised by an energy module defines.

According to an exemplary embodiment, wherein the switches of the switching PCB are implemented in an H-bridge. This is advantageous in that it has the effect, that the polarity of the individual energy modules in the current path through the energy module string can be controlled. Further, it is advantageous in that it has the effect, that the energy module elements behind the H-bridge can be either charge or discharged in dependency of the status of the H-bridge switches, independent of the string current direction

According to an exemplary embodiment, wherein the energy storage comprises at least two energy module strings, such as for example at least three energy module strings, each controlled by a string controller. This is advantageous in that it has the effect, that the energy storage can establish three-phase voltage and thereby be used in a three-phased system. An example of such three-phased system could be the auxiliary system of a wind turbine or the utility grid.

According to an exemplary embodiment, wherein the energy storage comprises an energy storage controller communicating with the string controllers. This is advantageous in that it has the effect, that the energy storage controller can act as a master controller controlling the string controllers comparable to slave controllers. In this way, the energy storage controller may provide setpoints, control strategies, etc. to the string controllers. Such control strategies may at least partly be established by input received by the energy storage controller from controllers or users external to the energy storage.

According to an exemplary embodiment, the energy storage comprises an energy storage controller communicating with the string controller, wherein the energy storage controller is configured for establishing an active power reference or a reactive power reference based on measured electric system reference and provide the established active or reactive power reference to the string controller. This is advantageous in that it has the effect, that in this way an autonomous frequency regulator system is established.

According to an exemplary embodiment, the string controller is configured to calculate a sequence in which the energy modules are turned on and turned off based on the dynamic performance list of the plurality of energy modules.

The dynamic performance list is advantageous in that the string controller always knows, according to predetermined control strategy, which energy module that should replace an energy module not complying with the minimum on-time. Hence, no time is wasted in the control e.g. on receiving measures from the energy modules, compare such measures and choosing an energy module or other comparing or determining steps.

According to an exemplary embodiment, an energy module of the plurality of energy modules is turned on and/or turned off if it complies with at least one of the conditions selected from the list comprising: minimum on-time and maximum temperature.

This is advantageous in that the minimum on-time and maximum temperature of the energy module in this way can be used as a threshold value for overruling the overall/normal control strategy.

According to an exemplary embodiment, the minimum on-time overrules the overall control strategy, when calculating the sequence in which the energy modules are turned on and turned off

This is advantageous in that if, according to the overall control strategy, an energy module should have been turned off, but does not comply with a threshold value for on-time or temperature, the overall control strategy is overruled and another turn off sequence is selected by the string controller.

According to an exemplary embodiment, the energy storage comprises at least two energy module strings, for example, at least three energy module strings.

According to an exemplary embodiment, the energy storage is a high powered energy storage for supplying stationary loads.

Moreover, the invention relates to an energy storage comprising an energy module string, the energy module string comprising a plurality of energy modules, each of the plurality of energy modules comprises four switches forming an H-bridge. Wherein one midpoint of the H-bridges of at least two energy modules is electrically connected, thereby establishing the energy module string. Wherein a string controller is configured for controlling the status of the switches of the H-bridge and thereby a current path through the energy module string so that the individual energy modules are turned on for at least a minimum on-time.

It should be noted that one energy storage can comprise several energy module strings which can be operated independently (parallel) or together (series connected) as desired.

According to an exemplary embodiment, wherein the string controller is configured to control the on-time of the individual energy modules different in two subsequent periods of an AC voltage output from the energy storage string.

According to an exemplary embodiment, wherein the string controller is configured to receive a frequency, current, voltage or power reference from an external controller and based heron configured to calculate the number of energy module of the energy module string that is needed to establish the desired energy module output voltage and the sequence in which the needed number of energy modules are turned on and turned off.

The desired energy module output voltage may be defined e.g. by its frequency and amplitude. Both of which can be controlled by the string controller controlling the switched of the switching PCB.

According to an exemplary embodiment, wherein the string controller is configured to calculate the sequence in which the energy modules are turned on and turned off based on a performance evaluation of the plurality of energy modules.

According to an exemplary embodiment of the invention, the string controller is configured to determine a sequence in which the energy modules are turned on and turned off based on the dynamic performance list of the plurality of energy modules.

In an exemplary embodiment of the invention, turning on and/or turning off an energy module of the plurality of energy modules complies with at least one of the conditions/operation parameters of the energy module selected from the list comprising: minimum on-time, minimum temperature, able to be charge and able to be discharged.

Complying with for example minimum on-time, advantageously ensures that the on-time does not exceed the minimum-on-time, and thereby fast transients may be reduced, in turn, advantageously reducing EMC, EMI and high frequency noise in the energy storage.

According to an exemplary embodiment of the invention, the string controller may turn on energy modules, starting with the first energy module on the dynamic performance list.

In other exemplary implementations of the invention, the string controller may turn on energy modules, starting with the last energy module of the dynamic performance list. However, it is within the scope of the invention to turn on and/or turn off energy modules in any order.

According to an exemplary embodiment of the invention, the sequence in which energy modules are turned off is different from the sequence in which the energy modules were turned on, when the output of the energy module is connected to one or more AC loads or to an AC grid. Thereby is avoided disturbances related to too short on-time of a switch and balancing of e.g. SOC of energy modules can be made.

In an exemplary embodiment of the invention, when establishing an AC waveform by the energy modules of a string of the energy storage, the first energy module of a string to be turned off by the string controller is different from the last energy module turned on by the string controller. Thereby is avoided a too short on-time of a switch a the peaks of the sinusoidal wave form.

According to an exemplary embodiment of the invention, the minimum on-time overrules the overall control strategy, when calculating the sequence in which the energy modules are turned on and turned off.

### THE DRAWINGS

For a more complete understanding of this disclosure, reference is now made to the following brief description, taken in connection with the accompanying drawings and detailed description, wherein like reference numerals represent like parts:

FIG. 1 illustrates energy modules of a string of an energy storage,

FIG. 2a illustrates an energy storage module,

FIG. 2b illustrates the switches of an energy storage module,

FIG. 3a illustrates on-time of an energy storage module in an AC scenario,

FIG. 3b illustrates on-time of an energy storage module in a DC scenario and

FIG. 4 illustrates a flow charge of the method of controlling the energy storage.

### DETAILED DESCRIPTION

The energy storage 7 of the present invention, can be used in several applications and for several reasons. To list a few, the energy storage 7 could be connected to the output of a generator of a wind turbine. Such generator is connected to a first end of an electric current path, the second end of which is connection to the utility grid. Between the generator and the utility grid a converter is typically located in the electric current path. Such converter may comprise a generator side converter connected to a grid side converter via a direct current (DC) link. Other configurations of a wind turbine may also be suitable for use with the present invention.

The energy storage 7 can be used in relation to all types of energy systems including wind turbine converters including DFIG (DFIG; Doubly Fed Induction Generator) converters, Full power 2 level back-to-back, Full power 3 level back-to-back, MMC (MMC; M Modular Multi-Level Converter), etc. The energy storage 7 can be located between the converter and the grid, in fact, it can be connected either in the dc link or between the converter and the transformer including a stator path of a DFIG configuration, in fact, it can be place on any AC or DC power line. Further, the energy storage 7 can be used in relation to all types of wind turbine generators including Induction Generator, Permanent Magnet Sync. Generator, Doubly Fed Induction Generator, Synchronous Generator, etc.

Further, the energy storage 7 can be used external to a wind turbine or other renewably energy generation systems as energy storage or grid support. One or more energy storages can be used as power supply to ships either when these are in harbour or between harbours to reduce use of fossil fuel generators and to reduce load on the electric grid of the harbour. In the following only one string of one energy storage is illustrated for simplicity, but the described principles could be used with several serial or parallel strings and several serial or parallel energy storages.

It should be noted, that the energy storage 7 including energy storage modules 8 preferably is located inside an electric cabinet. The electric cabinet protects the energy storage from environmental impact and may help maintaining a desired temperature, direct flow of cooling air, etc. Locating the energy storage in an electric cabinet is advantageous in that it is possible to located in sites of e.g. a wind turbine or other extreme sites.

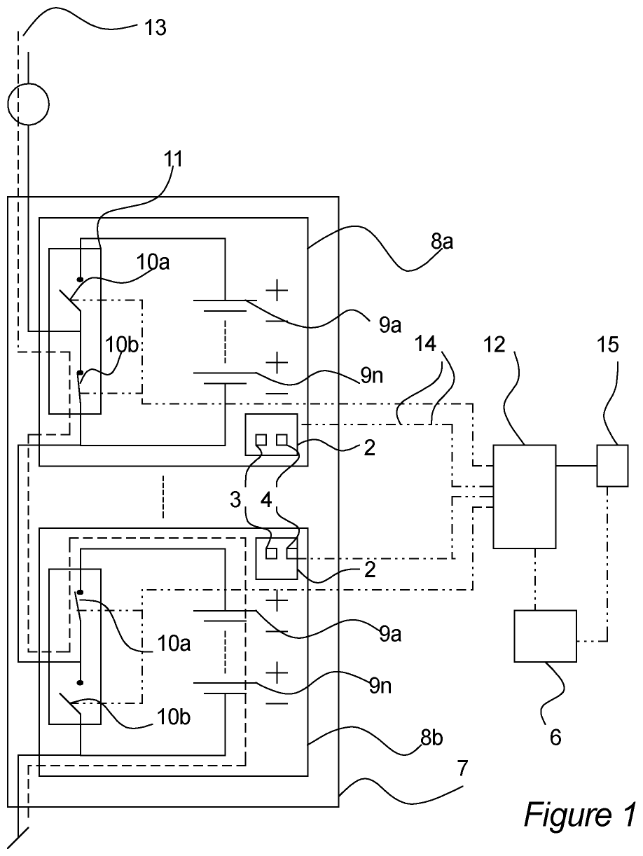

FIG. 1 illustrates the principles of the design of an energy storage 7 including the minimum elements of the energy storage 7. The energy storage 7 is built of a plurality of energy storage modules 8. Each of the energy storage modules 8 comprise at least two semiconductor switches 10a, 10b and at least one energy storage element 9. The energy storage element 9 is preferably a battery cell, but could also be other alternatives such as capacitors. The status of the semiconductor switches 10 is controlled by a string controller 12 and thereby, the string controller 12 is controlling a current path 13 through the energy storage modules 8 of the energy storage 7. It should be mentioned, that in embodiments, the current path 13 is also considered passing through an energy storage modules 8 even though the energy storage element 9 hereof is by-passed.

The way of the current path 13 through the energy storage 7 is determined by the status of the semiconductor switches 10 and is therefore controlled by the string controller 12. The status of the semiconductor switches 10 is determined based on availability of energy storage modules/energy elements 8, 9, health status of the energy storage module/energy elements 8, 9, state of charge of the energy storage elements 9, charging voltage available, desired/required voltage across/from the energy storage 7, health/wear of switches 10, temperature, internal resistance and/or historical on-time of the energy storage elements or energy storage modules etc. The status of a semiconductor switch 10 is changed between a conducting mode (switch closed) and a non-conducting mode (switch open). A deadtime between change from one status of the switch to another status is preferably adjustable between 10 nanoseconds and 1 microsecond, typically the value is a couple of 100 nanoseconds.

The availability of an energy storage element 9 may refer to a defect element such as a battery cell, in this case a battery module 8 will not be available. The health status of an energy storage element 9 may refer to the number of times the particular energy storage element 9 has been charged/discharge. The high number, the closer to end of life time of the energy storage element 9 hence, the string controller 12 may keep track of this number and activate energy storage module 8 trying to keep this number more or less the same i.e. balanced for all energy storage elements 9 of the energy storage 7. In the same way, health of switch 10 can also be estimated based on the number of times it has been switching.

The energy storage 7 illustrated in FIG. 1 comprises a first energy storage module 8a and a second energy storage module 8b each including a plurality of energy storage elements 9a, . . . , 9n. The energy storage elements 9a-9n of the first energy storage module 8a are bypassed because of the non-conducting status of switch 10a and the conducting status of switch 10b. The energy storage elements 9a-9n of the second energy storage module 8b is included in the current path 13 because of the conducting status of switch 10a and the non-conducting mode of switch 10b.

The status of the switches 10 is as mentioned controlled by string controller 12 communicating with the switches 10 via a wired control signal path 14 or a wireless communication protocol. The string controller 12 is preferably also connected to an external controller 15. The external controller may be a wind turbine controller, wind park controller, photovoltaic controller, grid controller, etc. providing references for output of the energy storage 7 in terms of frequency, voltage level, etc. to the string controller 12 and/or an energy storage controller 6. Further, as illustrated the string controller 12 preferably also receives input from a current sensor 1 which is implemented and measuring current conducted in the current path 13. On FIG. 1, one control signal path 14 is illustrated between the string controller 12 and the battery monitoring module 2 and on between the string controller 12 and the switch board 11. It should be mentioned that only one signal path 14 may be used to these two modules/boards 2, 11. Such alternative design may be advantageous in that it is possible for the string controller to verify, that the boards are physically mounted correct in line with the software of the string controller 12.

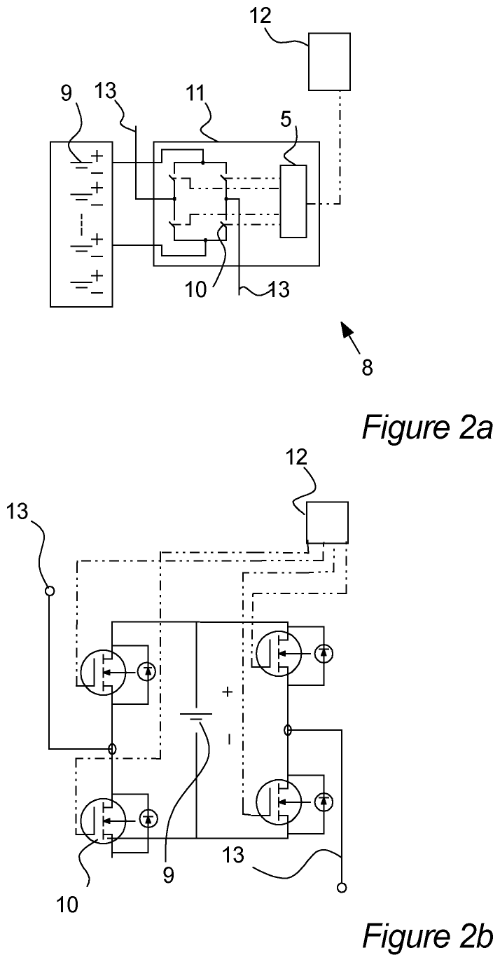

It should be mentioned, that FIG. 2 illustrates an example of series connected energy storage modules 8 which would be referred to as a string. A energy storage 7 may comprise more strings and in this case preferably each string has its own string controller 12. In this case these string controllers 12 may communicate with the energy storage controller 6 which again may communicate with the external controller 15.

The number of strings of an energy storage 7 may vary between 1 and 25 or even more, typically the number of stings reflects the number of phases and/or consumption of the system to which the energy storage is connected. In the strings, the energy storage modules 8 are series connected and each string typically comprises between 1 and 20 energy storage modules 8, preferably between 5 and 15. The number of energy storage modules 8 and thereby energy storage elements 9 is determined by the desired voltage over the energy storage 7 which is preferably higher than the peak voltage of the electric network to which the energy storage 7 is connected. The storage capacity of the energy storage 7 is determined by the application in which the energy storage 7 is used. Further, the number of energy storage elements 9 of the energy storage modules 8 may vary like the energy storage modules 8 does not have to be identical within the energy storage 7 and even not within the strings. Just as long as the string controller 12 is updated with information of what is behind the individual PCB (PCB; Printed Circuit Board) switch boards 11.

Preferably, the switches 10 are semiconductor switches 10 of the IGBT (IGBT; Insulated Gate Bipolar Transistor), MOSFET (MOSFET; Metal-Oxide-Semiconductor Field-Effect Transistor) type, GaN transistors (Gan; Gallium Nitride) or SiC transistors (SiC; Silicon Carbide), however other types of switches can also be used.

Preferably, commodity switches 10 are chosen in that they are well tested and low in price. The commodity switches are typically not designed for operation in high voltage (e.g. above 1000V) and with high currents (e.g. above 500 A) so the number of this type of switches is higher compared to designs using switches designed for higher voltage and currents. However, the increased number is compensated by the lower price of the commodity switches. A preferred type of switch 10 for use in the present invention is designed to currents of 100 A and voltages of 50V. At higher voltages of the preferred types of switches, the on-resistance of the semiconductor switch 10 is increasing and thereby the power loss in the switch 10.

Preferably, a reference to energy storage element 9, is a reference to a plurality of battery elements connected in series. The number of battery elements may vary, between 2 and 25 or even more in one column of series connected battery elements in an energy storage module 8. A typical column comprises between 10 and 20 series connected battery elements 9. The number of battery elements 9 in a column depends on requirements to the energy storage 7 and to a compromise between few cells 9 leads to low price and reduced power loss while many cells 9 reduces the harmonic current contribution and leads to a more reliable system in that the redundancy/flexibility in control is increased.

The energy storage elements 9 are preferably of the li-ion type since the characteristics of this battery type complies with the requirements of the energy storage 7 and the environment of e.g. a wind turbine. With this said, other battery types may also be used. As an example, one battery element 9, may be a 3.2V element which when connected with e.g. 14 similar elements 9 leads to a 48V battery pack within one energy storage module 8. Hence in this example, the energy storage 8 comprise one 48V battery which can be controlled by the switches 10 of the energy storage module 8. The capacity of the battery elements 9 is preferably between 10 Ah and 200 Ah or even higher, but as mentioned this is a design choice based on requirements to the energy storage 7 and prices of the system. Especially in the preferred embodiment where the switches 10 are mounted on a PCB, the maximum current is determined as the lower of the maximum current allowed through the current path 13 of the PCB 11 and the maximum battery current.

FIG. 2a schematically illustrates an energy storage 8. The switches 10 are implemented on a PCB 11. It is illustrated, that the PCB includes all four switches 10 together with gate drivers 5 controlling the switches 10. The gate drives 5 may be galvanic isolated from the current path 13. The galvanic isolation may be implemented as part of the gate driver 5.

FIG. 2b illustrates an electric diagram of the switch configuration according to an embodiment of the invention, where the diode of the semiconductor switch 10 is a body diode of a MOSFET. The energy storage module 8 illustrated on FIG. 2b includes four semiconductor switches 10 in an H-bridge. This is because the energy storage 7 is able to comply with AC current and voltage i.e. both negative and positive polarity and still be able to bypass the energy module 8 as described above. FIG. 2b only illustrate one battery element 9 in the energy storage module 8, however as understood from the above description, there may be several battery elements 9 in an energy storage module 8.

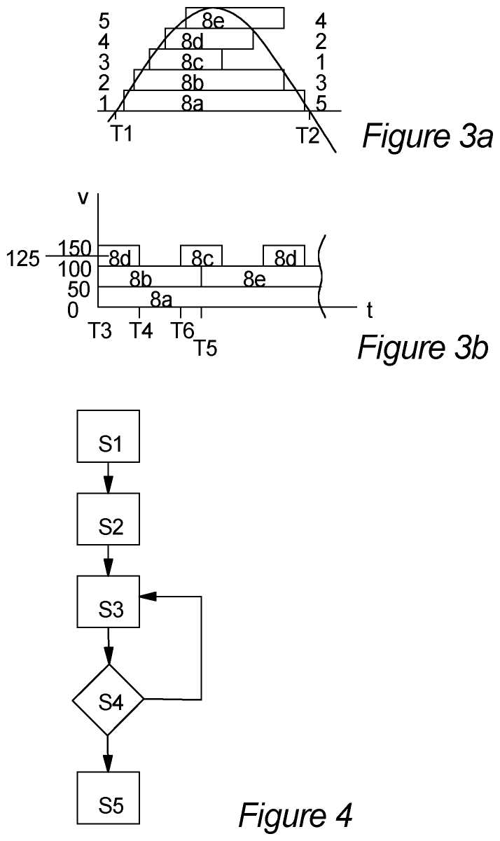

The energy storage 7 described with reference to FIGS. 1 and 2 is an example of a type of energy storage that can be controlled according to the inventive method described below with reference to FIGS. 3a and 3b.

It should be mentioned, that the string controller 12, in case the energy storage 7 comprises a plurality of strings may be communicating with the energy storage controller 15. If the energy storage only comprises one string, the energy storage controller may be superfluous. Hence, either the energy storage controller or the string controller communicates with an external controller 15 from which is received current, voltage, frequency etc. references for the delivery of energy from the string i.e. based on the received information, the string controller controls the output from the string. Further, the string controller 12 may receive information from sensors and be configured to, based here on, control if the energy storage should deliver energy to or receive energy from the electric system to which it is connected. The string controller knows the capacity of the energy storage modules and if it receives sensor input that energy is available the string controller may control the current path 13 (modules connected thereto) to charge energy storage modules that may need to be charged. The external controller may be a wind turbine controller, grid operator controller, etc.

Further, in an exemplary embodiment, the string controller are communicating with a battery monitoring system of each of the energy storage modules 8 comprising battery elements 9. The battery monitoring system knows hardware details of the battery elements 9 such as type of battery, operation temperature, capacity, internal resistance, historical on-time etc. Hence, at least based on this information, the string controller is able to calculate the state of charge, state of health, etc. and thereby the current path through the energy module string.

The battery monitoring system further may measure current by means of a current sensor 1 and the temperature by means of a temperature sensor 4 and module voltage by means of a voltage sensor 3. These sensors may be part of a battery monitoring module 2 comprising information of hardware configuration of the battery module and based on the sensors provide real-time information of the battery module to the string controller. Information from these sensors may also be used by the string controller to establish e.g. state of charge of the battery elements 9. Especially, information of which of the individual module 8 are connected to the current path along with a measurement of current in the current path can be used by the string controller to optimize control of the output voltage according to a desired overall control strategy including load distribution of the individual modules 8. In addition, replacement of a module 8 does not interrupt operation in that instantly, the string controller is aware of new type of battery elements 9, there capacity hereof, etc.

Information of temperature can be used to determine capacity of a battery element in case the battery element capacity is sensitive to ambient temperature. Thus, the string controller may consider the temperature of an energy module or battery element to determine if a given battery element or energy module should be switched in or out of the string, even at normal operating temperatures. Thus, while complying with the minimum on-time, the string controller may reduce the on-time of energy modules or battery elements with highest temperature, or even determine to switch these off of the string, even if they are within safe operating temperature

As mentioned, in an embodiment, the battery monitoring module 2 may also provide information of the battery cells 9 of the battery module 8. Hence, in a memory of the battery monitoring module 2 at least some of the following is stored, type of energy storage (battery, capacitor, etc.), type of e.g. battery cell 9, number of battery cells 9, capacity of such battery cell 9 (e.g. 25 Ah and 50 Ah) and thereby of the entire battery module 8, producer of the battery cell 9, production date of print 11, 18 and/or battery cells 9, installation date of battery module 8 in energy storage 7, switching information such as type, number of cycles, etc. It should be mentioned that the battery monitoring module 2 may be implemented as a PCB.

Summing up, the string controller establish a performance evaluation based on the information received from the different sensors and from information of energy module hardware configuration. A result of this performance evaluation may be one or more lists, so called dynamic performance lists, including all energy modules sorted according to SOC, SOH, voltage, temperature, number of switching of switches, number of times the energy modules has been connected to the current path, time the energy modules has been connected to the current path times, internal resistance, historical on-time of the energy modules, etc.

The energy modules may be sorted into the one or more dynamic performance lists based on a linear or non-linear function of the above mentioned parameters. Examples hereof may comprise a weighted average or a weighted sum of several of the above mentioned parameters. In an example, the first dynamic performance list may be sorted based on SOC with the energy modules having the highest SOC placed first on the dynamic performance list and the energy module having the lowest SOC placed last on the dynamic performance list. In this example, a second list may sort the energy modules based on on-time, for example historical on-time, and a third dynamic performance list may be sorted based on temperature of the energy modules and so forth.

Based on one or more of these lists, the string controller(s) and/or the energy storage controller may determine which of the energy modules that should be used to establish the energy storage output. In this example, the sting controller may be configured to give largest weight to the state of charge, second largest weight to SOH, while a smaller weight is given to temperature, when establishing which energy modules to turn on to establish the energy storage output. The string controller may further manages the on-time of each of the modules that is turned on, so that it complies with the minimum on-time, in order to minimize transients and thereby EMC, EMI and high frequency disturbances in the energy storage. In an embodiments, this determination may include considering an overall control strategy of e.g. maintaining a certain level of SOC, peak capacity, etc. In an embodiment the overall control strategy may be overruled by the minimum on-time, to reduce the above mentioned disturbances that may occur when the on-time of an energy module is short, for such as for example below the minimum on-time.

In a different example according to the invention, instead of generating a dynamic performance list for each of the mentioned parameters, for example SOC, the energy modules are simply sorted into one dynamic performance list, based on a linear combination of measurements of a selection of the above mentioned parameters, for example again, SOC, on-time and temperature. The string controller then utilize this list to select which energy modules to turn on and turn off in order to establish the energy storage output. In this example, the list is sorted so that the energy modules with highest SOC, lowest temperature and lowest on-time is placed first in the list. The string controller then switches on the energy modules, starting with the energy module placed first on the dynamic performance list, then it turns on the second energy module on the dynamic performance list, then the third energy module on the dynamic performance list etc., to establish the output of the energy storage.

FIG. 3a illustrates part of a voltage output curve from one string of an energy storage 7 as described above according to an exemplary embodiment. It can be seen, that the energy storage needs five energy storage modules 8 (8a-8e) to establish the illustrated voltage curve. Further it can be seen, that each of the energy storage modules 8a-8e adds 50V to the output voltage and that they are connected to the current path through the string in the numeric sequence with order 8a, 8b, 8c, 8d and 8e. Finally, it can be seen, that they are disconnected from the string in the numeric sequence 8c, 8d, 8b, 8e and 8a.

Notice that the sequence in which the energy modules are disconnected are following a different order compared to the sequence in which the modules where turned on. In a preferred implementation of the invention, and with reference to FIG. 3a, it may be preferred that the first energy module to be turned off, is different from the last energy module to be turned on. With reference to FIG. 3a, this means that 8e, which is the last energy module to be turned on, should not be the first energy module to be turned off. This is advantageous in that the frequency of the energy module output may be high, while the switching frequency of the energy modules may be kept lower to minimize wear on the switches and reduce transients of each of the energy modules, because each energy module is never switched on longer than the minimum on-time.

To avoid an on-time of an energy module which is below a predetermined minimum on-time, in this example, the modules 8 are not just turn off in an ordered sequence that is opposite the sequence in which they are turned on i.e. turn on (ordered): 1, 2, 3, 4 and turn off (ordered) 4, 3, 2, 1. If the sequence of which the modules are turned on is ordered (e.g. 1, 2, 3, 4) the sequence of which the modules are turned off is un-ordered (e.g. 4, 2, 3, 1 or 1, 3, 2, 4) or vice versa. Further, if the sequence in which the modules are turned on is unordered, they should be turned off in an alternatively unordered sequence. The sequence is determined based on a sorted list, for example a dynamic performance list, of the modules and one or more conditions as explained below.

FIG. 3a only illustrates a first half period of a sinusoidal curve. Typically, the second half period mirrors the first half period with respect to sequence in which the modules are turned on and off.

It should be mentioned that in an exemplary embodiment not illustrated, on FIG. 3a, if the temperature of the module 8a turns out to be too high during the first half period. Then the string controller will detect this and replace its contribution with a contribution from another module. Then, maybe within the same period, the temperature drops below the temperature threshold and the string controller may swap back and use module 8a again. An example of a maximum temperature is of an energy storage could be between 40° C. and 60° C., preferably between 45° C. and 55° C. Yet, it is within the scope of the invention, to also switch energy modules out of the string even if temperatures of the battery modules are within a normal safe operating range. Thus, according to the invention, temperature may not only be used to switch out energy modules with temperature above a specified operating temperature range.

In should be mentioned that by on-time should be understood the time in which the an energy module is connected to the string.

The total contribution from the energy storage modules 8a-8e is the same no matter the sequence of disconnection, as long as the sum of time, the energy storage modules are connected to the string does not change. More particularly, each of the levels of 50V has to be connected to the current path a time period specified by the requirements output voltage. Therefore, an energy storage module has to be connected throughout the time between time T1 and time T2. It does not need to be one particular energy storage module the whole time, but the time could be divided in contributions from several energy storage modules 8. In this way, the output stays the same, but what changes is the on-time of the individual modules 8. In other words, the on-time of the individual energy storage modules can be better balanced leading to a much better distribution of the wear among the switch module/switches of the energy module 8.

FIG. 3b illustrates a DC output curve of 125V. Since the energy storage modules are of 50V each, two energy storage modules would have to always be turned on and one energy storage module would have to be turned on 50% of the time. In the illustrated embodiment, energy storage module 8a is always turned on, whereas energy storage 8b and 8e supplies 50V shifting at time T5 and therefore together with module 8a supplies 100V. The remaining 25V is provided by turning on one module 50% of the time, in this embodiment, this is delivered partly by module 8c and partly by module 8d. The on-time between time T3 and T4 and between T4 and T6 is above the minimum on-time and thus no problems with respect to switching losses and EMI and EMC. However, if the control strategy is to balance the SOC of the individual storage modules 8, different modules can be connected to the current path 13. In exemplary embodiments of the invention, the control strategy may be overruled by the minimum on-time.

In the situation, where the string controller is asked to deliver a current to an AC load or AC grid, the string controller is controlling the individual modules to establish an output voltage complying with the system frequency of the system to which the current is to be delivered. Typically, the system frequency is 50 Hz or 60 Hz in AC systems.

The string controller controls the on-time of the individual modules 8 and as illustrated on FIG. 3a several modules 8 are needed to establish a desired amplitude of the output voltage. The frequency with which the string controller turns on or off the individual modules is in this document referred to as control frequency.

The on-time of an individual module could be referred to as module frequency. The on-time for the individual modules 8 is controlled by the string controller based on information received from all of the individual modules and in addition, maybe also an overall control strategy on how to establish the desired output voltage from the energy module. Hence, the on-time is determined in consideration of e.g. state of charge, state of health, system frequency and other requirements from the system to which the energy storage is connected to, etc. Hence, the string controller may be instructed to deliver 250 VAC and at least 10 A and it is then up to the string controller based on its knowledge of the individual modules 8, control strategy, current sensor input, etc. to determine how many modules that is needed and when these are to be connected to the current path 13. The string controller may in a preferred embodiment of the invention, further control the on time of individual energy modules so that the on-time of energy modules of a string is always above the minimum on-time.

The distribution of which energy storage modules 8 that has to be connected at which voltage levels (at FIG. 3 at 0V, 50V, 100V, 150V and 200V) is determined by the string controller 12. In an exemplary embodiment, this is done according to the flow chart of FIG. 4.

In the first step S1, an output reference is provided to the string controller 12. The output is typically received from an external data processor 15 such as a controller of the electric system to which energy storage 7 is connected. Such system could e.g. be a wind turbine, a solar system, utility grid and the like. Typically, the energy storage 7 is designed to a particular system and therefore optimized to deliver e.g. backup power to an auxiliary system of a wind turbine or solar plant. The energy storage may also be used as storage of surplus energy and to support utility grid. In such an exemplary embodiment, when needed, the wind turbine controller communicates to the energy storage controller 6, if the energy storage comprises more than one string (more than one phase) or to the string controller 12. Either a start signal is communicated if the energy storage/string controller knows which output is required by the “load” (in this example auxiliary system) or an output reference is provided. The output reference could be one or more of a voltage reference or a frequency reference.

In step S2, the string controller 12 is establishing a performance evaluation of the majority of the plurality of energy storage modules. An existing performance evaluation may be updated or a new may be made based on received input form battery monitoring module, sensors and/or information storage regarding previous use of the individual energy modules i.e. historic data.

In step S3, the sting controller 12 is using e.g. the received output reference together with the determined control strategy and the performance evaluation to establishes gate signals for the switches 10 of the energy storage modules 8. One control strategy could be balancing SOC or SOH equally between the energy storage modules 8 another control strategy could be the opposite namely using one or more of the storage modules 8 more than others and yet another could be a lower limit of switch time of switches 10 or a combination of these and others. The strategy of using one module more than others could be chosen if one storage module 8 seems to be close to end of life and service is planned shortly and the last capacity is to be squeezed out of it. The other way around, e.g. if service is not planed, there might be a desire to use such battery module 8 a little as possible.

No matter which control strategy that is chosen, the string controller establishes a turn on and a turn off sequence for the energy storage modules 8 that is required to comply with the required output reference and complies with the control strategy in light of the performance evaluation. It should be mentioned, that more energy storage modules 8 than needed may be included in the string in that it adds flexibility to how to establish the energy storage output.

The establishing of the turn on/turn off sequence includes the test in step S3 where the switching time i.e. time between a switch is turned on (closed) and turned off (opened) i.e. the time in which the energy storage module 8 controlled by the switches 10 is connected to the current path 13. To reduce switching loss, EMI and EMC disturbances in the energy storage 7, the on-time is preferably above a lower limit in the range of 80 us to 150 us e.g. 100 us or for example in the range of 200 to 300 us. This lower limit may be a predetermined minimum on-time. If the switching sequence according to the overall control strategy result in one energy module turns out to be below this lower limit, the lower limit overrules the overall control strategy and thus the sequence is adjusted accordingly. If for example the overall control strategy dictates that energy modules should be turned on sequentially according to SOC, starting with the energy module with the highest SOC, this results in that energy modules with the highest SOC will be turned on longest, and the last energy module to be turned on may be turned on in less than the minimum on-time at the peak of an AC wave form. In this example, the string controller may modify the sequence dictated by the overall control strategy, to prolong the on-time of that energy module having an on-time below the minimum on-time, while reducing the on time of one of the other energy modules that are turned on, even if this means that such energy module is then turned on for longer time than another energy module that is turned on having a higher SOC.

Step S3 is illustrated as an independent step and opposite, step S2 includes both establishing SOC or the like and calculate a pattern (sequence) thereon. It should be mentioned, that the presentation of the present method in a flow diagram is only to help understand and describe the steps and as the described order and content of the steps may be preferred, it is not absolutely necessary to follow strictly.

In step S4, gate signals according to the determined sequence is provided to gate rivers of the individual energy storage modules 8.

As mentioned, the energy storage module may comprise energy storage elements of different types. The elements 9, may be different battery types and capacitor types. Typically, only one type of battery/capacitor is used in one battery storage module 8, however this is not always the case. Two energy storage modules 8 in the same string may have different types of energy storage elements 9 i.e. a first may comprise batteries, a second may comprise a different type of batteries and a third may comprise capacitors.

This is possible to control in that each of the energy storage modules 8 preferably comprises a battery monitoring system module 2 that provide information of the status of the energy storage elements 9 of the energy storage module 8. Further, it comprises information of the hardware element comprised by the energy storage elements 9 including the type and number of battery or capacitor cells comprised by the energy storage element 9.

As can be understood from the above, the present invention relates to an energy storage 7 and the control of on-time of the energy storage module 8 hereof to establish a desired energy storage output voltage while remaining the system bandwidth and reducing switching loss. The output voltage may require several strings of energy modules 8. The control is made by one or more string controller 12 based on input from a controller 15 of the electric system to which the energy storage 7 is connected to, based on input from sensors of the electric system, trigger signals from the electric system, current sensor 17, the performance evaluation of the energy modules, etc.

The energy storage modules 8 comprises an energy module monitoring module 2 (referred to as battery monitoring module if the energy storage elements are batteries) via which the string controller 12 receives information of hardware configuration of the battery module 8 as well as real-time status of the battery elements 9. The status may include temperature and voltage measured from sensors 3, 4 which may be implemented on the battery monitoring module PCB.

The control according to the present invention is advantageous in that wear of the battery modules can be better distributed in that conduction of current from the modules can be controlled with a reduce noise occurring from the switches when turning on and off. Further, it is advantageous in that the switching time of the switches 10 can be controlled to be above a lower limit for example above a minimum on-time, which may be predetermined This reduces the EMC, EMI and high frequency noise in the energy storage system.

The energy storage may be used as local grid, backup, storage of surplus energy and grid support including supporting with respect to reactive or active power, frequency, etc.

More particularly according to an exemplary embodiment, the control of the charging or discharging i.e. the current/voltage of the sting is controlled according to the following steps.

First, a discrete electric reference (frequency, voltage, current or power) is provided to the string controller. The reference may be received from a controller of the load or from the energy storage controller and is via an algorithm transformed to a continuous electric reference such as a sinusoidal waveform.

Second, one or more electric values are measured of the energy storage module sting. If the electric reference is a voltage, then the voltage of the string is measured.

Third, the string controller is calculating a voltage reference based on the continuous electric reference and the measure electric values. This voltage reference determines the number of energy modules that is needed from the string to go from the current voltage to the next voltage level determined by the continuous electric reference. It should be note that the voltage refence instead of a voltage reference could be a frequency, current or power reference in other exemplary embodiments.

Fourth, this voltage reference is then used to determine the number of energy modules that needs to be connected to the current path. The energy module that is to be connected is selected from a list, for example a dynamic performance list, which preferably comprises each of the energy modules of the string. The energy modules of the list is sorted according to one or more of SOC, SOH, temperature or other relevant electric parameters, including for example internal resistance. This and the below is referred to as performance evaluation or dynamic performance evaluation.

The sorted list of energy modules may be established and updated with time intervals. The minimum time between two updates of the list is the frequency with which the string controller is receiving measurements from the battery monitoring system (if the battery elements are batteries) i.e. the sampling frequency of the battery monitoring system. Alternatively, the time intervals can be determined based on the frequency of the system to which energy storage is connected i.e. every period or half period. Alternatively, the time interval could be a predetermined time of 1 ms, 1 second, 1 minute or any times therebetween. Accordingly, the time interval may be determined by the application in which the energy storage is used.

As an example, if the energy modules are sorted according to SOC and the energy modules are to be charged, the energy module having the lowest SOC i.e. the bottom module of the list is selected first. In contrary, if the energy module is to be discharged the energy module having the highest SOC i.e. the top module of the list is selected first. As illustrated on FIG. 3a, the energy module that is connected first 8a, is the one that is charged/discharged the most.

Fifth, before string controller send turn-on signal to the switches of the energy module selected from the list, the sting controller examines if this energy modules complies with one or more conditions. These conditions may include maximum/minimum temperature, minimum on-time, minimum off-time, charge/discharge, etc.

The minimum on-time is as mentioned to avoid switching losses due to high module frequency. To comply with the minimum on-time, the string controller can control the time an individual energy module is turned on, turned off or a combination thereof.

Further, to avoid transients, the string controller can ensure a minimum time between one module is turned off and then turned on again or vice versa.

### LIST

1. Current sensor
2. Battery monitoring module
3. Voltage sensor
4. Temperature sensor
5. Gate drivers
6. Energy storage controller
7. Energy storage
8. Energy storage modules
9. Energy storage elements
10. Semiconductor switches
11. PCB switch board
12. String controller
13. Current path
14. Control signal path
15. External controller

1-29. (canceled)

30. A method of controlling the on-time of a plurality of energy modules of an energy storage,
the energy storage comprising a plurality of series connected energy modules forming an energy module string, wherein each of the individual energy modules are connected to the energy module string by a plurality of switches configured in an H-bridge,
wherein a string controller is controlling which of the individual energy modules that is part of a current path through the energy module string, by control of the status of a plurality of the switches,
wherein the string controller is controlling the frequency of the energy module string voltage according to an electric system reference of a system to which the energy storage is connected, and
wherein the string controller is controlling the switches of the individual energy modules so that each of the individual energy modules that are required to be included in the current path to establish the energy modules string voltage are included in the current path for at least a minimum on-time.

31. A method according to claim 30, wherein the string controller is establishing the on-time of the individual energy modules dynamically according to a dynamic performance evaluation of the plurality of energy modules of the energy module string.

32. A method according to claim 30, wherein the string controller performs the dynamic performance evaluation prior to each turning on of an energy storage module.

33. A method according to claim 30, wherein the dynamic performance evaluation includes sorting the plurality of energy modules into a dynamic performance list.

34. A method according to claim 30, wherein sorting the plurality of energy modules into a dynamic performance list is based on at least one energy module parameter of the list comprising: on-time, state of charge, state of health, temperature and internal resistance.

35. A method according to claim 30, wherein the dynamic performance evaluation includes sorting the plurality of energy modules according to at least one of the list comprising: state of charge, state of health, temperature of the plurality of energy modules.

36. A method according to claim 30, wherein the dynamic performance evaluation further includes that the selection of which energy module that is to be connected next to the current path complies with at least one of the conditions selected from the list comprising: minimum on-time, minimum temperature, able to be charge and able to be discharged.

37. A method according to claim 30, wherein the string controller is furthermore controlling the amplitude of the energy module string voltage according to input received from controllers external to the energy module string.

38. A method according to claim 30, wherein the performance evaluation includes a wear evaluation established by the string controller based on historic data of use of the energy modules.

39. A method according to claim 30, wherein the energy storage comprises at least two energy module strings, each controlled by a string controller.

40. A method according to claim 30, the energy storage comprises an energy storage controller communicating with the string controller, wherein the energy storage controller is configured for establishing an active power reference or a reactive power reference based on measured electric system reference and provide the established active or reactive power reference to the string controller.

41. A method according to claim 30, wherein the string controller is configured to calculate a sequence in which the energy modules are turned on and turned off based on the dynamic performance list of the plurality of energy modules.

42. A method according to claim 30, wherein the string controller is configured to control the sequence in which the energy modules are turned on and turned off so that each energy module comprised by the sequence complies with at least one of the conditions selected from the list comprising: above a minimum on-time and below a maximum temperature.

43. A method according to claim 30, wherein the energy storage is a high powered energy storage for supplying stationary loads.

44. An energy storage comprising an energy module string, the energy module string comprising a plurality of energy modules, each of the plurality of energy modules comprises four switches forming an H-bridge,
wherein one midpoint of the H-bridges of at least two energy modules is electrically connected, thereby establishing the energy module string, and
wherein a string controller is configured for controlling the status of the switches of the H-bridge and thereby a current path through the energy module string so that the individual energy modules are turned on for at least a minimum on-time.

45. An energy storage according to claim 44, wherein the string controller is configured to control the on-time of the individual energy modules different in two subsequent periods of an AC voltage output from the energy storage string.

46. An energy storage according to claim 44, wherein the string controller is configured to calculate the sequence in which the energy modules are turned on and turned off based on a performance evaluation of the plurality of energy modules.

47. An energy storage according to claim 44, wherein the string controller is configured to determine a sequence in which the energy modules are turned on and turned off based on the dynamic performance list of the plurality of energy modules.

48. An energy storage according to claim 44, wherein the energy storage is a high powered energy storage for supplying stationary loads.

49. An energy storage according to claim 44, wherein the energy storage comprises at least two energy module strings, for example, at least three energy module strings.
